(19) United States
(12) Patent Application Publication
(10) Pub. No.: US 2007/0279191 A1
(43) Pub. Date: Dec. 6, 2007

(54) RFID system

(75) Inventors: Masaaki Yamamoto, Kokubunji (JP); Takanori Yamazoe, Hadano (JP); Toshiyuki Kuwana, Yokohama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/802,018

(22) Filed: May 18, 2007

(30) Foreign Application Priority Data
May 19, 2006 (JP) JP2006-140013

(51) Int. Cl. H04Q 5/22

(52) U.S. Cl. 340/10.1; 340/572.7; 340/10.2; 343/876

(57) ABSTRACT

A technique of reducing the interference wave occurred between a plurality of reader/writers in an environment in which a plurality of RFID systems are operating. An RFID system includes a plurality of reader/writers and a controller for controlling the plurality of reader/writers. Each reader/writer includes a body, antennas, and a distributor for selecting one antenna from the antennas. The controller selects an antenna having a positional relationship in which the interference wave is small from the antennas of each reader/writer, and giving a command for the antenna to the body of each reader/writer. Each reader/writer selects one antenna from the antennas based on the command from the controller and transmits a command to the RFID.

### CROSS-REFERENCE TO RELATED APPLICATION

The present application claims priority from Japanese Patent Application No. JP 2006-140013 filed on May 19, 2006, the content of which is hereby incorporated by reference into this application.

### TECHNICAL FIELD OF THE INVENTION

The present invention relates to RFID systems in which a plurality of RFIDs and a plurality of reader/writers perform radio communication, in particular, to a technique for reducing interference wave produced between the reader/writers.

### BACKGROUND OF THE INVENTION

The inventors of the present invention have reviewed the following technique for the RFID system.

Generally, the RFID (Radio Frequency Identification) system is configured by a radio called reader/writer 501 and a plurality of RFIDs 100, as shown in FIG. 1A. The reader/writer 501 is configured by a body 500 and an antenna 200. Each RFID 100 is configured by an IC chip 101, an antenna 102, and a battery 103, as shown in FIG. 1B. The RFID 100 is broadly divided into an active RFID equipped with the battery 103 and a passive RFID not equipped with the battery 103.

The passive RFID not equipped with the battery is operated by electromagnetic wave energy from the reader/writer 501. Therefore, the reader/writer 501 transmits a modulated wave (hereinafter, referred to as an interrogation signal or command 502), and thereafter, it must continuously transmit the continuous wave as the electromagnetic wave energy while the passive RFID 100 demodulates the command 502 and retransmits (hereinafter, referred to as response signal or response 503) depending on the incorporated data, as necessary, to read the data stored in the passive RFID.

On the other hand, the active RFID 100 equipped with the battery 103 transmits the command 502 to the reader/writer 501, and thereafter, stops the transmission and waits for the response 503 from the active RFID 100 to read the data stored in the active RFID 100.

Techniques related to such RFID system include techniques disclosed in Japanese Patent Application Laid-Open Publication No. 2003-283367 (Patent Document 1) and Japanese Patent Application Laid-Open Publication No. 2005-157645 (Patent Document 2).

The technique of Patent Document 1 is an interrogator system in which a plurality of interrogators radio communicate the same signal to a moving transponder (IC card), where the plurality of interrogators are arranged with the communicationable region of the antenna overlapped to expand the communicationable region, and transmission and reception by the antenna of each interrogator are synchronized to prevent interference of one interrogator receiving a transmission signal from another interrogator.

The technique of Patent Document 2 relates to switching the plurality of antennas in a reading device body so that the adjacent antennas are not simultaneously turned on when a storage box (with a plurality of radio tags inside) is placed on the reading device body, reading the plurality of radio tags in the storage box, stopping the reading when the number of radio tags registered in advance and the number of read radio tags match, and displaying the result to a display unit.

### SUMMARY OF THE INVENTION

The inventors of the present invention have reviewed the technique of the RFID system described above and found the following.

The RFID system is widely used in logistical and distributional applications, and for example, a system of reading the information in the RFID attached to an article conveyed on a belt conveyor to manage the article, as shown in FIG. 2, has been proposed.

FIGS. 2A and 2B show one example in which a plurality of RFID systems are operating. The configuration of such example has a belt conveyor 300 and a belt conveyor 800 lined in parallel at close distance, and the RFID 100 attached to the article and the like moving in the conveying direction on the belt conveyor 300. Since it is not clear at which portion of the article the RFID 100 is attached, it is difficult to accurately know the position of the RFID 100 in advance. Therefore, the antenna is arranged so as to surround the belt conveyor 300 in order to accurately recognize the RFID 100 regardless of the direction the RFID 100 is facing. For example, as shown in FIG. 2A, the antenna 200 and an antenna 202 are arranged at the sides of the belt conveyor 300 so as to face each other, and an antenna 201 is arranged above the belt conveyor.

Each antenna 200, 201, 202 is connected to the body 500 by way of a distributor 400, and one antenna is selected according to an instruction from the body 500 to transmit the command. The reader/writer in the RFID system is configured by a plurality of antennas, a distributor for selecting the antennas, and a body.

Since the reader/writer installed in each belt conveyor is the same, a description on the reader/writer for the belt conveyor 800 will be omitted.

In the RFID system configured as above, the reader/writers arranged at close distance independently select one antenna to transmit a command respectively, and thus the recognition of the RFID may not be accurately performed in each reader/writer due to each other's interference wave.

As an example, the interference wave in a case where the antenna 200 and an antenna 702 simultaneously transmit commands and that of in a case where the antenna 200 and an antenna 700 simultaneously transmit commands will be compared and reviewed. The carrier wave frequency used in transmission and reception is the same at each antenna and is 953 MHz.

When the antenna 200 and the antenna 702 simultaneously transmit commands, each antenna is arranged with the radiating surface of the electromagnetic wave facing towards each other. Therefore, if each antenna has directivity as shown in FIGS. 3A, 3B, and 3C, by way of example, there is barely any power loss due to directivity of each antenna. Therefore, when the transmission power of each antenna is the same, each belt conveyor width is 5 [m], and the distance between the belt conveyors is 1 [m], the command transmitted by the antenna 200 is received with a free space propagation loss of about 53 [dB] in 11 [m] as the interference wave to the antenna 702, as shown in FIG. 2B. Similarly, the command transmitted by the antenna 702 is received with a free space power loss of about 53 [dB] in 11 [m] as the interference wave to the antenna 200.

When the antenna 200 and the antenna 700 simultaneously transmit the commands, the radiating surface of the electromagnetic wave of the antenna 700 is arranged facing away from the antenna 200. Accordingly, a power loss of about 28 [dB] occurs when the command transmitted by the antenna 200 is received as interference wave by the antenna 700 due to the directivity of the antenna of FIGS. 3A, 3B, and 3C. Therefore, the command transmitted by the antenna 200 is received with a loss of about 76 [dB], which is the sum of the free space propagation loss of about 48 [dB] in 6 [m] and the loss by the directivity, as the interference wave of the antenna 700. Similarly, the command transmitted by the antenna 700 is received as the interference wave by the antenna 200 with a loss of about 76 [dB].

Consequently, the power of the interference wave is larger by 23 [dB] although the distance between the antennas is longer when the antenna 200 and the antenna 702 are simultaneously used than when the antenna 200 and the antenna 700 are simultaneously used.

The power loss of the interference wave in all possible antenna combinations under the same condition is shown in FIG. 4. A difference of about 35 [dB] is found between the maximum and the minimum power losses of the interference wave.

Accordingly, when each reader/writer independently selects the antenna to issue the command, the reader/writer may be strongly subjected to interference wave depending on the combination of the antennas used. The power of the interference wave tends to fluctuate depending on the carrier wave frequency of the interference wave and the frequency response characteristic of a receiving filter generally arranged in the body of the reader/writer. One example of the frequency response characteristic of a receiving filter is shown in FIG. 5. As shown in FIG. 5, the power of the interference wave bercomes higher when the carrier wave frequency of the interference wave is f₁ rather than when the carrier wave frequency of the interference wave is f₂ with the carrier wave frequency used by the reader/writer in reception as f_{c}. Therefore, the reader/writer is subjected to strong interference wave when the carrier wave frequency used by the reader/writer in reception and the carrier wave frequency of the interference wave are close.

Therefore, each reader/writer arranged at close distance may be subjected to strong interference wave depending on the combination of the antennas selected by each reader/writer and the carrier wave frequency used in transmission and reception in the RFID system.

An object of the present invention is to provide a technique for reducing the interference wave occurred between a plurality of reader/writers in an environment where a plurality of RFID systems are operating.

The above and other objects and novel characteristics of the present invention will be apparent from the description of this specification and the accompanying drawings.

The typical ones of the inventions disclosed in this application will be briefly described as follows.

More particularly, an RFID system according to the present invention comprises: a plurality of reader/writers for transmitting an interrogation signal to an RFID and receiving a response signal; and a controller for controlling the plurality of reader/writers. The reader/writers each includes: a body; a plurality of antennas; and a distributor for selecting one antenna from the plurality of antennas. The controller has a function of commanding each body of the plurality of reader/writers which antenna to select from the plurality of antennas of the plurality of reader/writers, selects an antenna having a positional relationship in which the interference wave is small, and instructs respective main bodies of the plurality of reader/writers. The plurality of reader/writers each selects one antenna from the plurality of antennas based on the instruction from the controller and transmits an interrogation signal via the distributor.

The effects obtained by typical aspects of the present invention will be briefly described below.

The interference wave occurred between a plurality of reader/writers in an environment in which a plurality of RFID systems are operating is reduced, and the RFID data can be read with a plurality of reader/writers arranged at high density.

### BRIEF DESCRIPTIONS OF THE DRAWINGS

FIG. 1A is an explanatory view showing a typical RFID system related to the present invention;

FIG. 1B is an explanatory view showing the typical RFID system related to the present invention;

FIG. 2A is a view showing a configuration of an RFID system reviewed as a basis of the present invention;

FIG. 2B is a view showing a configuration of the RFID system reviewed as a basis of the present invention;

FIG. 3A is a view showing one example of the directivity of an antenna used in a first embodiment and a second embodiment of the present invention;

FIG. 3B is a view showing one example of the directivity of the antenna used in the first embodiment and the second embodiment of the present invention;

FIG. 3C is a view showing one example of the directivity of the antenna used in the first embodiment and the second embodiment of the present invention;

FIG. 4 is a view showing one example of power loss of the interference wave assumed when each reader/writer selects the antenna in the RFID system reviewed as a basis of the present invention;

FIG. 5 is a view showing one example of frequency response characteristic of a receiving filter of a reader/writer related to the present invention;

FIG. 6 is a view showing one example of a configuration of an RFID system according to the first and a fourth embodiments of the present invention;

FIG. 7 is a timing chart showing one example of a process of when performing a communication between an antenna transmitting a command and the RFID in the RFID system according to the first and the fourth embodiments of the present invention;

FIG. 8 is a view showing one example of a configuration of the RFID system according to the second embodiment of the present invention;

FIG. 9 is a view showing one example of power loss of the interference wave assumed when controller is not used in the RFID system according to the second embodiment of the present invention;

FIG. 10 is a timing chart showing one example of a process of when performing a communication between an antenna transmitting a command and the RFID in the RFID system according to a third and the fourth embodiments of the present invention;

FIG. 11 is a timing chart showing one example of a process of when performing a communication between an antenna transmitting a command and the RFID in the RFID system according to the third and the fourth embodiments of the present invention; and

FIG. 12 is a timing chart showing one example of a process of when performing a communication between an antenna transmitting a command and the RFID in the RFID system according to third and fourth embodiments of the present invention.

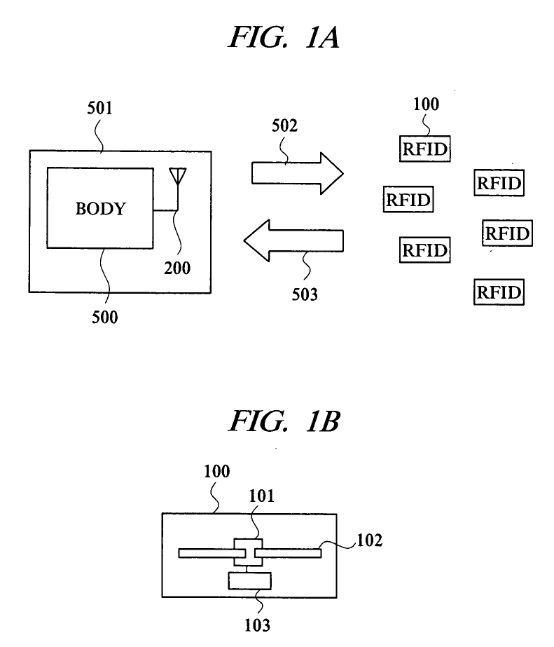

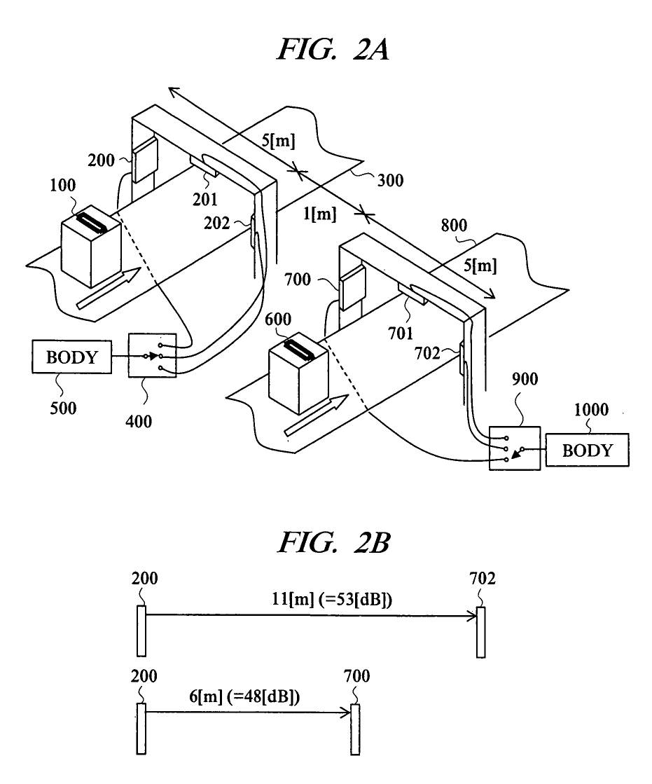

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

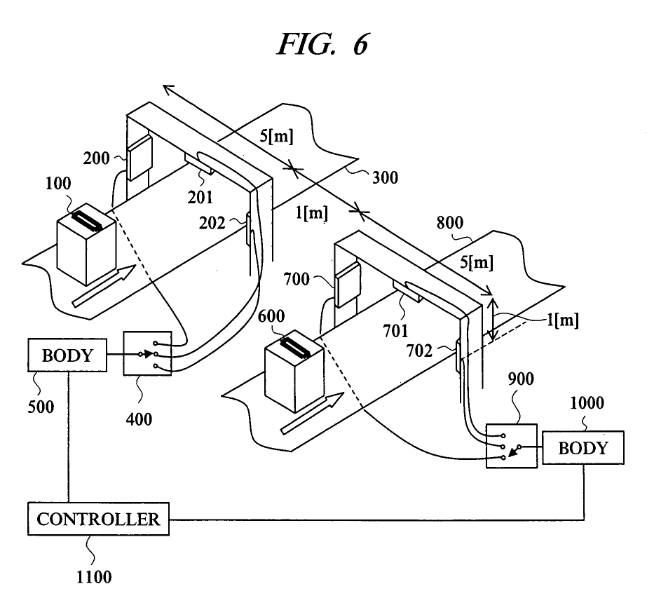

FIG. 6 is a view showing a configuration of an RFID system according to a first embodiment of the present invention.

First, one example of the configuration of the RFID system according to the first embodiment will be described with reference to FIG. 6. In the RFID system according to the first embodiment, a belt conveyor 300 and a belt conveyor 800 are lined in parallel at close distance, and an RFID 100 attached to an article or the like moves on the belt conveyor 300 in the conveying direction. Since it is not known at which part of the article the RFID is attached, it is difficult to accurately know the position of the RFID 100 in advance. Therefore, the antenna is arranged so as to surround the belt conveyor 300 in order to accurately recognize the RFID 100 regardless of which direction the RFID 100 is facing. For instance, as shown in FIG. 6, an antenna 200 and an antenna 202 are arranged so as to face each other at the sides of the belt conveyor 300, and an antenna 201 is arranged above the belt conveyor 300. Each antenna 200, 201, 202 is connected to a body 500 by way of a distributor 400, and one antenna is selected according to the instruction from the body 500 to transmit the command.

The reader/writer in the RFID system is configured by: the plurality of antennas 200, 201, 202; the distributor 400 for selecting the antennas; and the body 500.

Similarly, a reader/writer of the belt conveyor 800 is configured by: a plurality of antennas 700, 701, 702; a distributor 900 for selecting the antennas; and a body 1000.

The body 500 and the body 1000 are connected to a controller 1100. The controller 1100 has a function of commanding each body which antenna to select from the plurality of antennas connected to the body, and a function of giving a command for what carrier wave frequency to be used by each reader/writer in transmission and reception to each body.

Each belt conveyor width is 5 [m], the distance between the belt conveyors is 1 [m], the height from the center of the antenna 200 to the radiating surface of electromagnetic wave of the antenna 201 is 1 [m], and the antenna 201 is arranged at the central part of the belt conveyor width. Since the reader/writer installed on each belt conveyor is the same, a description on the reader/writer of the belt conveyor 800 will be omitted.

A method of reducing the interference wave received by each reader/writer using the RFID system having the configuration described above will be described below.

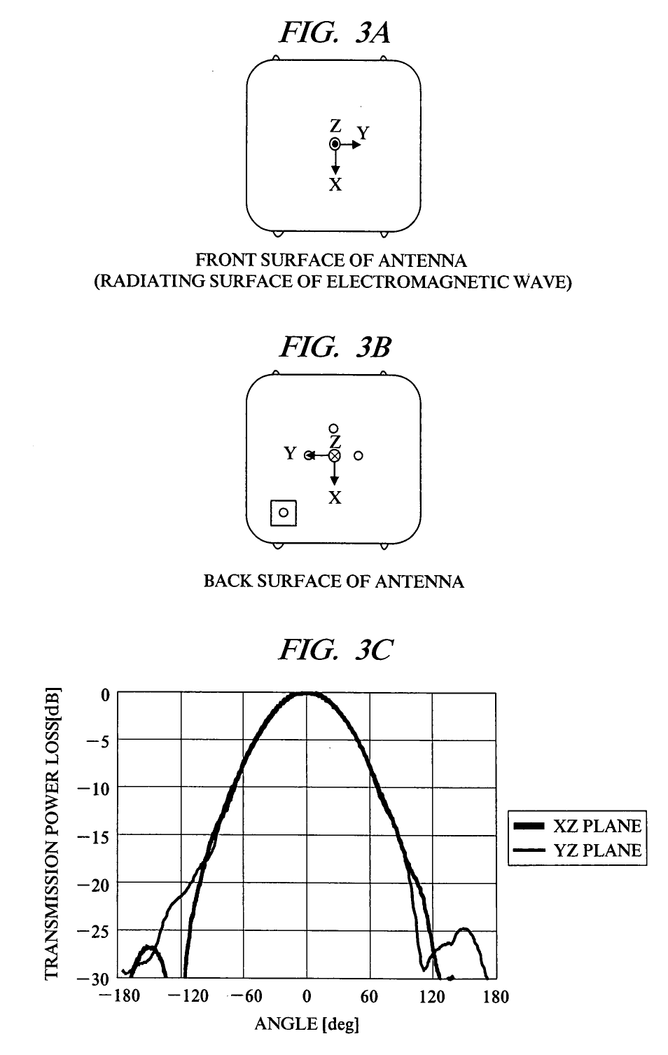

FIGS. 3A, 3B, and 3C are views showing one example of the directivity of the antenna used in the first embodiment, where FIG. 3A shows the front surface of the antenna (radiating surface of electromagnetic wave), FIG. 3B shows the back surface of the antenna, and FIG. 3C shows the relationship between angle and transmission power loss in the XZ plane and the YZ plane.

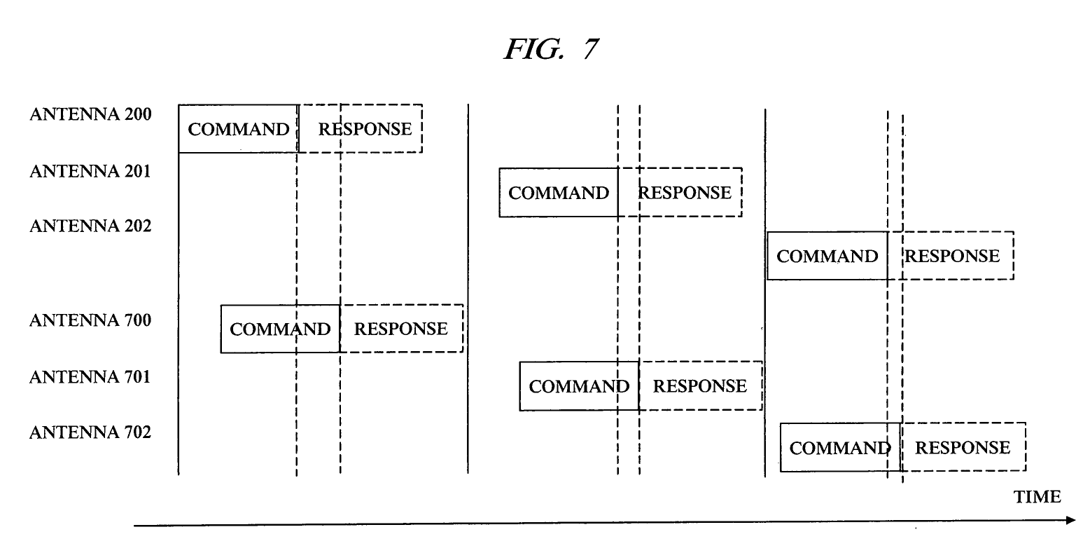

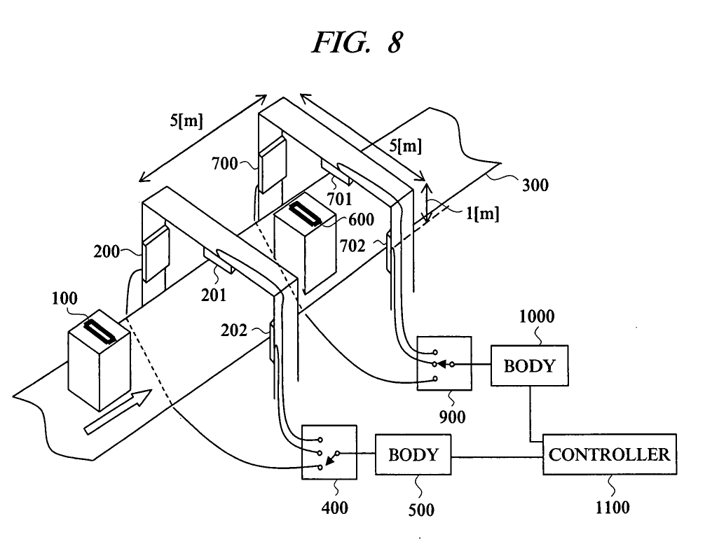

FIG. 7 is a timing chart showing one process example when communication is performed between the antenna transmitting a command and the RFID in the RFID system of the first embodiment.

As shown in FIG. 7, the antenna 200 and the antenna 700 having the same orientation are selected to transmit commands and receive responses from the RFID 100 and 600. The controller 1100 issues a command to use the antennas in combination in the order of selecting the antenna 201 and the antenna 701, and thereafter, selecting the antenna 202 and the antenna 702.

The interference wave between the reader/writers is then reduced compared to the conventional RFID system. Specifically, the influence of the interference wave will be described below. The carrier wave frequency used in transmission is the same at each antenna and is 953 MHz.

First, when the antenna 200 and the antenna 700 are selected to transmit the commands, the radiating surface of the electromagnetic wave of the antenna 700 is arranged facing away from the antenna 200. Therefore, if each antenna has the directivity shown in FIG. 3 by way of example, a power loss of about 28 [dB] occurs when the command transmitted by one antenna is received by the other antenna as an interference wave. As shown in FIG. 7, if the response received at the antenna 200 is subjected to interference by the command from the antenna 700 and the interference wave received by each antenna is received with a loss of about 76 [dB], which is the total of the free space propagation loss about 48 [dB] in a distance of 6 [m] between the antennas and the loss due to directivity when the transmission power of each antenna is the same.

When the antenna 201 and the antenna 701 having the same orientation are selected to transmit the commands, the radiating surfaces of the electromagnetic wave of the antenna 701 and the antenna 201 are both arranged to face downward. Therefore, the power loss of about 30 [dB] occurs when the command transmitted by one antenna is received by the other antenna as an interference wave according to the antenna directivity of FIG. 3. As shown in FIG. 7, if the response received at the antenna 201 is subjected to interference by the command from the antenna 701, the interference wave received by each antenna is received with a loss of about 78 [dB], which is the total of the free space propagation loss of about 48 [dB] in a distance of 6 [m] between the antennas and the loss due to the directivity.

When the antenna 202 and the antenna 702 having the same orientation are selected to transmit the commands, the radiating surface of the electromagnetic wave of the antenna 202 is arranged facing away from the antenna 702. Therefore, the power loss of about 28 [dB] occurs when the command transmitted by one antenna is received by the other antenna as an interference wave according to the antenna directivity of FIG. 3. As shown in FIG. 7, the response received at the antenna 202 is subjected to interference by the command of the antenna 702, and the interference wave received by each antenna is received with a loss of about 76 [dB], which is the total of the free space propagation loss of about 48 [dB] in a distance of 6 [m] between the antennas and the loss due to directivity.

Accordingly, the power loss of the interference wave when transmitting the command is substantially constant at about 76 to 78 [dB], and the interference wave received among respective reader/writers becomes largest when the power loss is minimum of about 76 [dB].

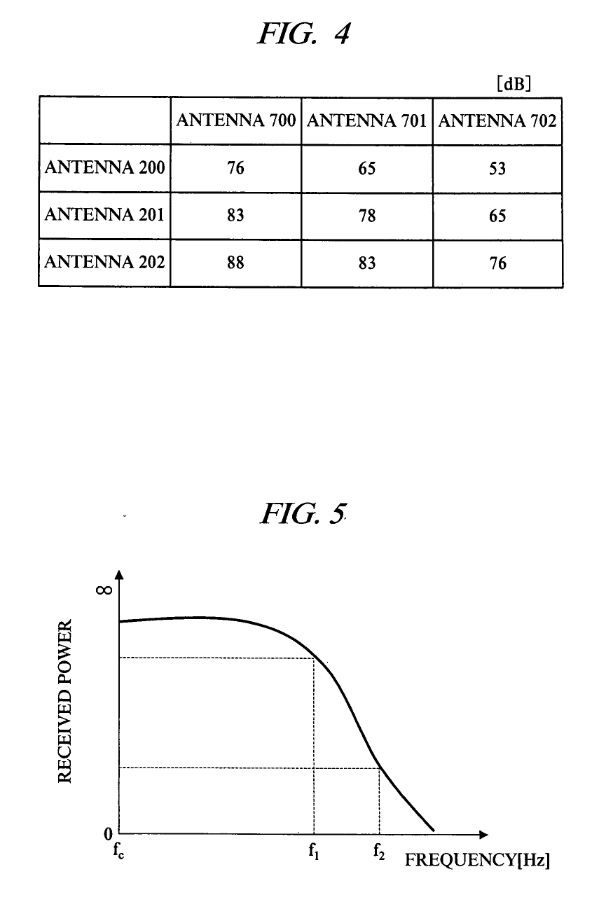

The minimum power loss of the conventional RFID system is about 53 [dB] as shown in FIG. 4. Therefore, the minimum power loss of the interference wave of the RFID system according to the first embodiment is higher by about 23 [dB] than the conventional RFID system under the same conditions. Thus, the interference wave is reduced compared to the conventional RFID system. The interference wave is further reduced by selecting the carrier wave frequency used by each reader/writer in transmission and reception with the frequency interval set apart simultaneously with selecting the antenna of each reader/writer.

For instance, if the frequency response characteristic of the receiving filter of each reader/writer has the characteristic shown in FIG. 5, the power of the interference wave becomes lower when the carrier wave frequency of the interference wave of one reader/writer is at f₂ with respect to the carrier wave frequency f_{c} of another reader/writer than when the carrier wave frequency of the interference wave is at f₁. Therefore, the interference wave can be reduced by selecting the carrier wave frequency used by each reader/writer in transmission and reception with the frequency interval set apart.

### Second Embodiment

FIG. 8 shows a configuration of an RFID system according to a second embodiment of the present invention.

In the RFID system according to the second embodiment, the RFID 100 and the RFID 600 attached to an article and the like move on the belt conveyor 300 in the conveying direction. Since it is not known at which part of the article the RFID is attached, it is difficult to accurately know the position of the RFID 100 in advance. Therefore, the antenna is arranged so as to surround the belt conveyor 300 in order to accurately recognize the RFID 100 regardless of which direction the RFID 100, 600 are facing. For instance, as shown in FIG. 8, the antenna 200 and the antenna 202, as well as the antenna 700 and the antenna 702 are arranged so as to face each other at the sides of the belt conveyor 300, and the antenna 201 and the antenna 701 are arranged above the belt conveyor 300.

The antennas 200, 201, and 202 are connected to the body 500 by way of the distributor 400, and one antenna is selected according to the instruction of the body 500 to transmit a command. The reader/writer in the RFID system is configured by the plurality of antennas 200, 201, 202, the distributor 400 for selecting the antenna, and the body 500. The body 500 is connected to the controller 1100. The controller 1100 has a function of commanding each body which antenna to select from the plurality of antennas connected to the body, and a function of giving a command for what carrier wave frequency to be used by each reader/writer in transmission and reception to each body.

The antennas 700, 701, and 702 are connected to the body 1000 by way of the distributor 900, and one antenna is selected according to the instruction of the body 1000 to transmit a command. The reader/writer in the RFID system is configured by the plurality of antennas 700, 701, 702, the distributor 900 for selecting the antennas, and the body 1000. The body 1000 is connected to the controller 1100.

Respectively, the belt conveyor width is 5 [m], the distance between the antenna 200 and the antenna 700 is 5 [m], the height from the center of the antenna 200 to the radiating surface of electromagnetic wave of the antenna 201 is 1 [m], and the antenna 201 is arranged at the central part of the belt conveyor width. Each reader/writer installed on the belt conveyor 300 has similar configuration and function.

Each antenna is assumed to have the directivity shown in FIG. 3, similar to the first embodiment.

A method of reducing the interference wave received by each reader/writer using the RFID system having the configuration described above will be described below.

For instance, as shown in FIG. 7, the antenna 200 and the antenna 700 having the same orientation are selected to transmit commands, and receive responses from the RFID 100 and, 600. The controller 1100 issues a command to use the antennas in combination in the order of selecting the antenna 201 and the antenna 701, and thereafter, selecting the antenna 202 and the antenna 702. The interference wave is thereby reduced compared to the conventional RFID system. Specifically, the influence of the interference wave will be described below. The carrier wave frequency used in transmission is the same at each antenna and is 953 MHz.

In the selection of the antennas in the above combination, the radiating surface of the electromagnetic wave of each selected antenna is facing the same direction as shown in FIG. 8 in all antenna combinations. Therefore, if each antenna has the directivity shown in FIG. 3 by way of example, a power loss of about 30 [dB] is produced when the command transmitted by one antenna is received by the other antenna as an interference wave.

In the above antenna combinations, the interference wave received by each antenna is received with a loss of about 76 [dB], which is the total of the loss of the free space propagation loss of about 46 [dB] in a distance of 5 [m] between the antennas and the loss due to the directivity.

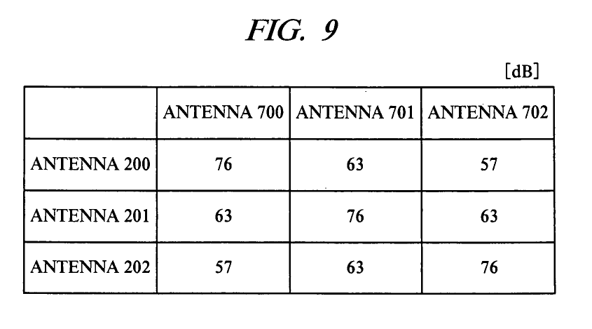

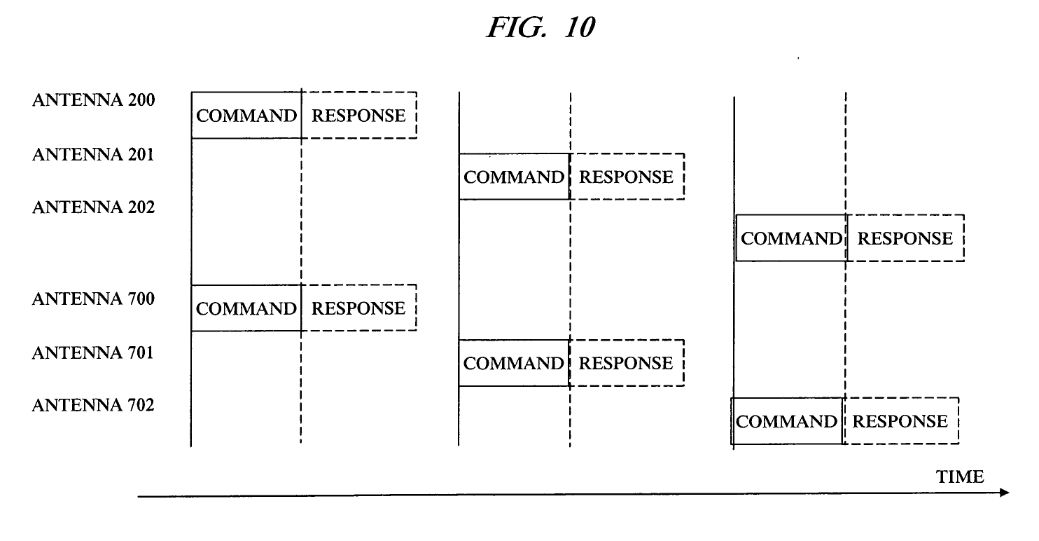

Accordingly, the power loss of the interference wave when transmitting the command is substantially constant at about 76 [dB]. When each reader/writer independently selects the antenna and transmits the command without using the controller 1100 under the same condition, the power loss of the interference wave in all assumed antenna combinations is as shown in FIG. 9.

The minimum power loss of the conventional RFID system is about 57 [dB] as shown in FIG. 9. Therefore, the minimum power loss of the interference wave in the second embodiment is higher by about 19 [dB] than the conventional RFID system under the same conditions. Thus, the interference wave is reduced compared to the conventional RFID system. The interference wave is further reduced by selecting the carrier wave frequency used by each reader/writer in transmission and reception with the frequency interval set apart simultaneously with selecting the antenna of each reader/writer.

For instance, if the frequency response characteristic of the receiving filter of each reader/writer has the characteristic shown in FIG. 5, the power of the interference wave becomes lower when the carrier wave frequency of the interference wave by one reader/writer is f₂ with respect to the carrier wave frequency f_{c} of another reader/writer than when the carrier wave frequency of the interference wave is f₁. Therefore, the interference wave can be reduced by selecting the carrier wave frequency used by each reader/writer in transmission and reception with the frequency interval set apart.

### Third Embodiment

A configuration of an RFID system according to a third embodiment of the present invention is the same as the configuration of FIG. 6 of the first embodiment.

In the third embodiment, the controller 1100 has functions of: monitoring the transmission and reception state of each reader/writer to match the transmission and reception timings of each reader/writer; stopping and standing by the command transmission from a specific reader/writer when the command length to be transmitted differs among the reader/writers; and giving a command for the carrier wave frequency to be used by each reader/writer in transmission and reception to each body.

A method of reducing the interference wave received by each reader/writer using the RFID system of the above configuration will be described below.

FIGS. 10, 11, and 12 are timing charts showing one example of a process when communication is performed between the antenna transmitting the command and the RFID in the RFID system according to the third embodiment of the present invention.

For instance, the transmission and reception state of the body 500 and the body 1000 of each reader/writer is monitored and the transmission and reception timings of the command are matched as in FIG. 10 by the controller 1100. Through such control, the command and the response will not be simultaneously transmitted and received by each reader/writer, and thus the reader/writer will not be subjected to interference wave if the RFID is an active RFID.

However, if the RFID is a passive RFID, the interference wave occurs between the reader/writers since each reader/writer transmits the continuous wave even when receiving the response. In the case of the passive RFID, therefore, the interference wave is reduced by matching the transmission and reception timings of the command, and at the same time, selecting the carrier wave frequency used by each reader/writer in transmission and reception with the frequency interval set apart.

For instance, if the frequency response characteristic of the receiving filter of each reader/writer has the characteristic shown in FIG. 5, the power of the interference wave becomes lower when the carrier wave frequency of the interference wave by one reader/writer is f₂ with respect to the carrier wave frequency f_{c} of another reader/writer than when the carrier wave frequency of the interference wave is f₁. Therefore, the interference wave can be reduced by selecting the carrier wave frequency used by each reader/writer in transmission and reception with the frequency interval set apart.

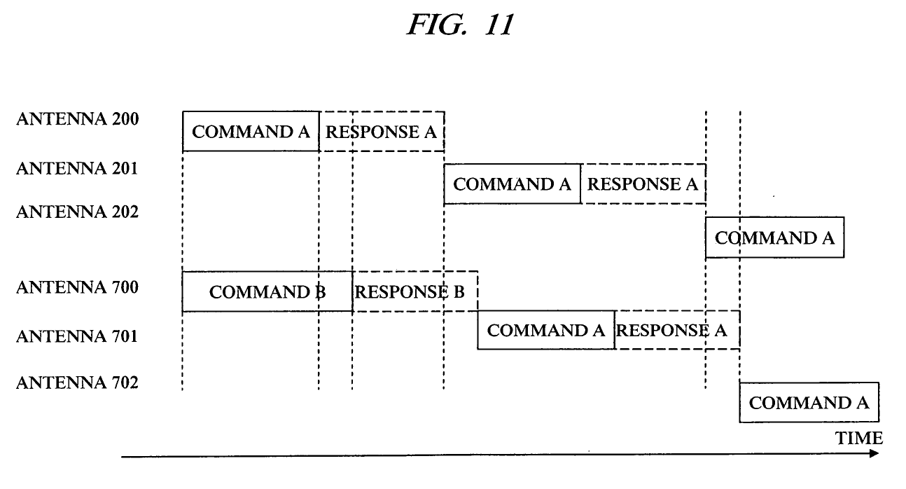

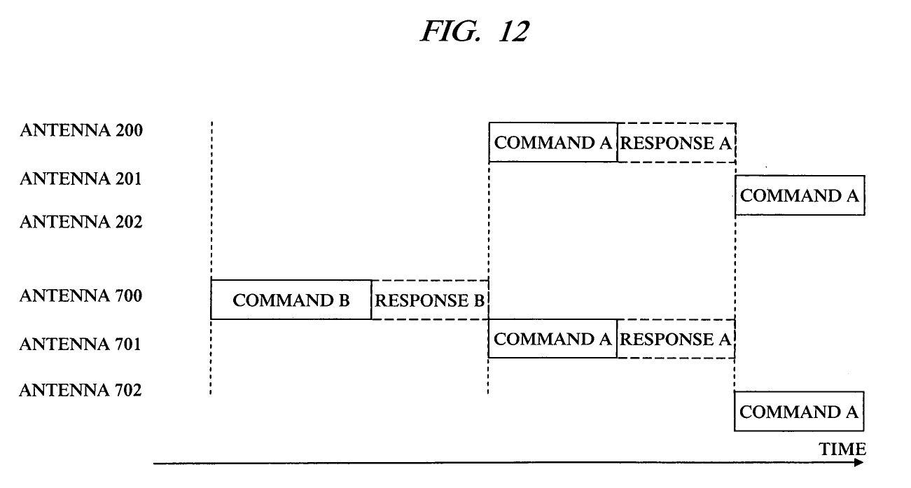

However, assuming a case in which the antenna 200 transmits a command A, and at the same time, the antenna 700 transmits a different command B as shown in FIG. 11, the former part of the response A with respect to the command A of the antenna 200 temporally overlaps with the command B transmitted from the antenna 700 due to the difference in length of the command. Therefore, the possibility of the response A being subjected to the interference wave of the command B increases regardless of whether the RFID is active type or passive type.

Consequently, the controller 1100 performs a control of monitoring the transmission and reception states of each reader/writer and matching the transmission and reception timings of each reader/writer, and giving a command the carrier wave frequency used by each reader/writer in transmission and reception to each body, and at the same time, performs the control of stopping the transmission of the command from a specific reader/writer and waiting. For instance, the command A transmitted from the antenna 200 is transmitted delayed by the transmission timing worth the time interval of the command B and the response B, as shown in FIG. 12. The command of each reader/writer and the response of the RFID are thereby avoided from being temporally overlapped, and the interference wave is reduced.

In the same manner, same effects are obtained for the RFID system having the configuration of FIG. 8 of the second embodiment.

### Fourth Embodiment

A configuration of an RFID system according to a fourth embodiment of the present invention is the same as the configuration of FIG. 6 of the first embodiment.

In the fourth embodiment, the controller 1100 has a function of commanding each body on which antenna to select from the plurality of antennas connected to each body, and a function of: monitoring the transmission and reception state of each reader/writer to match the transmission and reception timings of each reader/writer; stopping and standing by the command transmission from a specific reader/writer when the command length to be transmitted differs among the reader/writers; and giving a command for the carrier wave frequency used by each reader/writer in transmission and reception to each body.

A method of reducing the interference wave received by each reader/writer using the RFID system of the above configuration will be described below.

Similar to the first embodiment, the antenna 200 and the antenna 700 having the same orientation are selected to transmit the command, and receive the responses from the RFID 100, 600, as shown in FIG. 7. The controller 1100 issues a command to use the antennas in combination in the order of selecting the antenna 201 and the antenna 701, and thereafter, selecting the antenna 202 and the antenna 702. The interference wave received by each reader/writer is thereby reduced compared to the conventional RFID system. Specifically, the influence of the interference wave will be described below. The carrier wave frequency used in transmission is the same at each antenna and is 953 MHz.

For instance, the transmission and reception state of the body 500 and the body 1000 of each reader/writer is monitored and the transmission and reception timings of the command are matched as in FIG. 10 by the controller 1100. Through such control, the command and the response will not be simultaneously transmitted and received by each reader/writer, and thus the reader/writer will not be subjected to interference wave if the RFID is an active RFID.

However, if the RFID is a passive RFID, the interference wave occurs between the reader/writers since each reader/writer transmits the continuous wave even when receiving the response. In the case of the passive RFID, therefore, the interference wave is reduced by matching the transmission and reception timings of the command, and at the same time, selecting the carrier wave frequency used by each reader/writer in transmission and reception with the frequency interval set apart.

For instance, if the frequency response characteristic of the receiving filter of each reader/writer has the characteristic shown in FIG. 5, the power of the interference wave becomes lower when the carrier wave frequency of the interference wave by one reader/writer is f₂ with respect to the carrier wave frequency f_{c} of another reader/writer than when the carrier wave frequency of the interference wave is f₁. Therefore, the interference wave can be reduced by selecting the carrier wave frequency used by each reader/writer in transmission and reception with the frequency interval set apart.

In order to reduce the interference wave of each reader/writer in the passive RFID, the controller 1100 selects the antenna with the method same as the first embodiment from the plurality of antennas of each reader/writer simultaneously with monitoring the transmission/reception state of each reader to match the transmission and reception timings of each reader/writer and the control to giving a command for the carrier wave frequency to be used by each reader/writer in transmission and reception to each body. The interference wave is thereby further reduced.

However, assuming a case in which the antenna 200 transmits a command A, and at the same time, the antenna 700 transmits a different command B as shown in FIG. 11, the former part of the response A with respect to the command A of the antenna 200 temporally overlaps with the command B transmitted from the antenna 700 due to the difference in length of the command. Therefore, the possibility of the response A being subjected to the interference wave of the command B increases regardless of whether the RFID is active type or passive type.

The controller 1100 thus performs a control of: selecting which antenna to choose from the plurality of antennas connected to the body; monitoring the transmission and reception states of each reader/writer to match the transmission and reception timings of each reader/writer; and giving a command for the carrier wave frequency used by each reader/writer in transmission and reception to each body, and at the same time, performs the control of stopping the transmission of the command from a specific reader/writer and waiting.

For instance, the command A transmitted from the antenna 200 is transmitted delayed by the transmission timing worth the time interval of the command B and the response B, as shown in FIG. 12. The command of each reader/writer and the response of the RFID are thereby avoided from being temporally overlapped, and the interference wave is reduced.

In the same manner, same effects are obtained for the RFID system having the configuration of FIG. 8 of the second embodiment.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. An RFID system comprising a plurality of reader/writers for transmitting an interrogation signal to an RFID and receiving a response signal, and a controller for controlling the plurality of reader/writers;
wherein the plurality of reader/writers each includes: a body; a plurality of antennas; and a distributor for selecting one antenna from the plurality of antennas;
the controller has a function of giving a command to each body of the plurality of reader/writers which antenna to select from the plurality of antennas of the plurality of reader/writers;
the controller selects an antenna having a positional relationship in which an interference wave is small, and giving a command for the antenna to each body of the plurality of reader/writers; and
the plurality of reader/writers each selects one antenna from the plurality of antennas based on the command from the controller and transmits the interrogation signal via the distributor.

2. The RFID system according to claim 1,
wherein the respective antennas have a directivity property in which its gain become strong in one direction and weak in another direction.

3. The RFID system according to claim 2,
wherein the controller selects antennas of respective reader/writers according to an antenna arrangement of each arranged reader/writer and the directivity property.

4. The RFID system according to claim 2,
wherein the controller selects antennas having the same orientation from the plurality of antennas of the plurality of reader/writers as the antenna having a positional relationship in which the interference wave is small.

5. The RFID system according to claim 3,
wherein the controller further has a function of: selecting a carrier wave frequency to be used for transmitting and receiving the interrogation signal and a response signal; and giving a command for the carrier wave frequency to each body of the plurality of reader/writers.

6. The RFID system according to claim 5,
wherein the controller selects a carrier wave frequency to be used by each reader/writer in transmission and reception with a frequency interval set apart, and giving a command for the carrier wave frequency to the body of each reader/writer.

7. The RFID system according to claim 3,
wherein the controller further has a function of: monitoring transmission and reception states of the interrogation signal and the response signal in the respective plurality of reader/writers; and giving a command for the transmission and reception timings of each reader/writer to the body of each reader/writer.

8. The RFID system according to claim 7,
wherein the controller monitors the transmission and reception state of the each reader/writer to match the transmission and reception timings of each reader/writer; stops and stands by the radio communication other than that of a specific reader/writer if a time width of the transmission signal of each reader/writer differs; selects the carrier wave frequency to be used in transmission and reception; and gives a command for a carrier wave frequency to the body of each reader/writer.
